(19) United States
(12) Patent Application Publication
(10) Pub. No.: US 2025/0134011 A1
(43) Pub. Date: May 1, 2025

(54) LEAF MULCHER

(71) Applicant: Gregory J Alfone, Boonton, NJ (US)

(72) Inventor: Gregory J Alfone, Boonton, NJ (US)

(21) Appl. No.: 18/662,325

(22) Filed: May 13, 2024

Related U.S. Application Data
(60) Provisional application No. 63/629,450, filed on Oct. 27, 2023.

(51) Int. Cl. A01G 20/47

(52) U.S. Cl. CPC A01G 20/47

(57) ABSTRACT

A leaf mulcher for shredding fallen leaves into lead dust. The leaf mulcher includes a backpack-type housing encasing an engine and a vacuum motor. A hose extends from the housing and includes an entry port for drawing leaves under vacuum force created by the vacuum motor. One or more mulching blades are mounted within the hose adjacent to the entry port, wherein one or more mulching blades are operated by the drive member and one or more mulching blades can cut the leaves entering the hose through the entry port into leaf cuttings. One or more grinding units are mounted within the hose and behind one or more mulching blades, wherein the one or more grinding units are configured to shred the leaf cuttings received from the one or more mulching blades into leaf dust.

### CROSS-REFERENCE TO RELATED APPLICATIONS

This application claims priority from a U.S. Provisional Patent Appl. No. 63/629,450, filed on Oct. 27, 2023, which is incorporated herein by reference in its entirety.

### FIELD OF INVENTION

The present invention relates to a leaf mulcher, and more particularly, the present invention relates to a leaf mulcher with fallen leaves grinding functionality.

### BACKGROUND

Fallen leaves litter around in lawns, sideways, and the like creating an unpleasant sight. urban and suburban environments, the accumulation of fallen leaves not only creates an unsightly mess but also presents practical problems such as increased costs for disposal and potential environmental hazards like clogging storm drains. The use of leaf blowers is quite common both in residences and commercial places. However, the use of leaf blowers comes with its own set of issues such as noise pollution, which can be disruptive and bothersome to both individuals and communities. Use of more than one leaf blower in proximity may create noise that is often unbearable. Moreover, there is a risk of injury associated with operating leaf blowers.

A need is therefore appreciated for an apparatus for removing the leaf debris without causing aforesaid problems with traditional leaf blowers.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a leaf mulcher that can draw the fallen leaves utilizing vacuum suction and reduce the same to fine particles in near real-time.

Another object of the present invention is that the leaf mulcher makes much less noise compared to the leaf blowers.

Still, another object of the present invention is that the leaf mulcher reduces the leaf debris to exceedingly small particles.

A further object of the present invention is that the leaf mulcher can efficiently dispose of fallen leaves from an area.

Still, a further object of the present invention is that the leaf mulcher is faster in operation.

Yet a further object of the present invention is that the leaf debris converted to fine particles can be quickly decomposed.

An additional object of the present invention is that the leaf mulcher can quickly dispose of leaf debris.

Still, an additional object of the present invention is that the process is much more economical by avoiding the need to collect, bag, and transport the collected leaves.

In one aspect, disclosed is a leaf mulcher comprising a housing encasing a drive member and vacuum motor. A hose extending from the housing, the hose has an entry port configured to draw leaves under vacuum force created by the vacuum motor. One or more mulching blades mounted within the hose adjacent to the entry port, the one or more mulching blades operated by the drive member, the one or more mulching blades are configured to cut the leaves entering the hose through the entry port into leaf cuttings. One or more grinding units mounted within the hose and behind the one or more mulching blades, wherein the one or more grinding units are configured to shred the leaf cuttings received from the one or more mulching blades into leaf dust. The housing is in the form of a backpack configured to be worn over the shoulders of a user. The drive member is an engine, the engine configured to drive the one or more mulching blades, the vacuum motor, and the one or more grinding units. The leaf mulcher further comprises a fuel tank mounted below the housing. The drive member is a motor, the motor configured to drive the one or more mulching blades, the vacuum motor, and the one or more grinding units. The leaf mulcher further comprises an exit port for leaf dust.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

The drawing shows a schematic view of a leaf mulcher, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a leaf mulcher that can be used to dispose of fallen leaves from an area including lawns, gardens, pavements, roads, and the like. The fallen leaves are also referred to herein as litter leaves or leaf debris. Instead of blowing off the fallen leaves, the disclosed leaf mulcher can draw the fallen leaves by utilizing vacuum suction, thus making the process faster while making significantly less noise. Moreover, any risk of potential injury to the operator or nearby people is avoided. Also, any risk of blowing the leaves to undesired places is avoided.

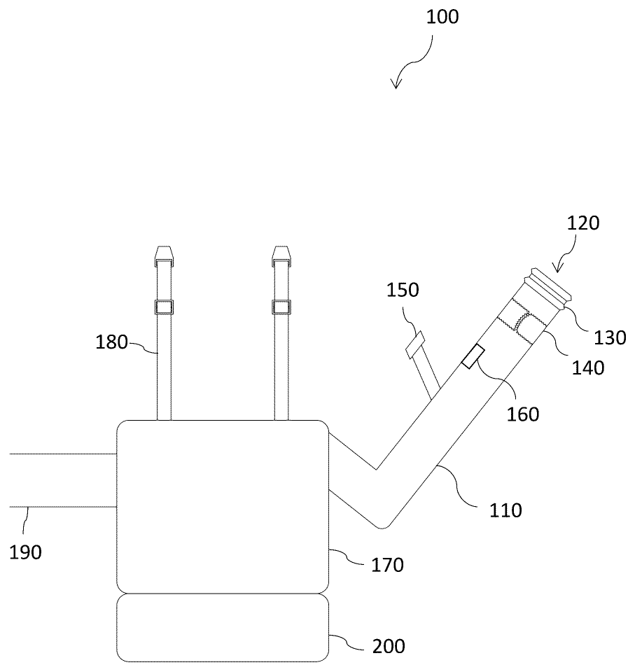

FIG. 1 shows a schematic view of the leaf mulcher 100. The leaf mulcher 100 includes a hose 110 extending from a backpack housing 170. Preferably, the hose can be of an ergonomic shape that allows a user to comfortably hold the hose in his hand and the main apparatus can be hung as a backpack over the shoulders of the user. The hose at the open end includes a vacuum entry port 120 through which leaves can be drawn into the hose under vacuum. In operation, the hose can be pointed at leaf debris by the user, and the fallen leaves get sucked into the hose. The vacuum entry port can be about 3″ in size, however, the size of the vacuum entry port can be varied without departing from the scope of the present invention.

Behind the vacuum entry port are one or more sets of mulching blades 130 mounted within the hose. The mulching blades can be mounted into the hose through a bracket that may allow the blades to be removed from the housing. For example, the blades can be removed for cleaning, sharpening, or replacing the blades. More than one blade can be used for shredding the leaves into small pieces. For example, two blades can the leaves by scissoring action into small pieces.

In certain implementations, the blades can be rotated at an extremely high speed by a motor or an engine. For example, a 150 cc to 200 cc engine motor can be used to drive different components of the disclosed apparatus. The engine component can be mounted into a backpack housing 170 for ease of carrying the same. The backpack housing may include a suitable number of straps 180 for hanging it over the shoulders of the user. A fuel tank 200 can be used to hold the fuel for the engine. The fuel tank can be positioned adjacent to the engine for fuel supply. The drawing shows the fuel tank adjacent to the backpack housing which encases the engine. It is to be noted that a driving mechanism, such as an engine or motor, can be varied without departing from the scope of the present injection. Also, the fuel tank can be replaced by any energy source, for example, batteries in the case of the electric motor as the drive. member.

In certain implementations, the engine or motor or any other drive member can also run a vacuum motor. An exit port 190 for the vacuum motor can be provided along the backpack so that the vacuum is released behind the user using the disclosed apparatus. The leaf dust can exit through this exit port 190 behind the user. It is an advantage of the present invention that the leaf cuttings are further reduced to dust by grinders which is explained below. The leaf dust exits through the exit port and there is no need for bagging and transporting the leaf dust. This avoids the additional burden of the bagging the collected leaves on the user, as well as the need for collecting any leaves cuttings.

First, the leaves are drawn towards the mulching blades from the entry port utilizing the suction force created by the vacuum motor. The mulching blades can cut the leaves in small pieces. The mulching blades can be operated at a high speed to shred the leaves into very small pieces. Behind the mulching blades is a grinding wheel 140 that can further reduce the leaf cuttings received from the mulching blades into leaf dust i.e., very small particles. The leaf dust can exit through the exit port.

In certain implementations, the grinding wheel includes two grinding gears with pointed edges that run close to each other in opposite directions so that leaf cuttings passing through the two grinding wheels are reduced to leaf dust or fine particles.

In the hose, transparent windows can be provided at suitable locations to view inside, such as to view the blades and grinders. Any clogging within the housing can be inspected through the transparent windows.

A vacuum lever 150 can also be seen extending from the hose, and the same can be used for asserting a vacuum at the entry port. The lever can be engaged and disengaged to manipulate the vacuum conditions at the entry port and the suction of leaf debris and pass it under vacuum force through the blades and grinders. One more lever 160 is provided for adjusting the vacuum levels.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A leaf mulcher comprising:
a housing encasing a drive member;
a vacuum motor;
a hose extending from the housing, the hose has an entry port configured to draw leaves under vacuum force created by the vacuum motor;
one or more mulching blades mounted within the hose adjacent to the entry port, the one or more mulching blades operated by the drive member, the one or more mulching blades are configured to cut the leaves entering the hose through the entry port into leaf cuttings; and
one or more grinding units mounted within the hose and behind the one or more mulching blades, wherein the one or more grinding units are configured to shred the leaf cuttings received from the one or more mulching blades into leaf dust.

2. The leaf mulcher of claim 1, wherein the housing is in a form of a backpack configured to be worn over shoulders of a user.

3. The leaf mulcher of claim 2, wherein the drive member is an engine, the engine configured to drive the one or more mulching blades, the vacuum motor, and the one or more grinding units.

4. The leaf mulcher of claim 3, wherein the leaf mulcher further comprises a fuel tank mounted below the housing.

5. The leaf mulcher of claim 2, wherein the drive member is a motor, the motor configured to drive the one or more mulching blades, the vacuum motor, and the one or more grinding units.

6. The leaf mulcher of claim 1, wherein the leaf mulcher further comprises:
an exit port for leaf dust.
